(19) United States
(12) Patent Application Publication
(10) Pub. No.: US 2020/0142903 A1
(43) Pub. Date: May 7, 2020

(54) METHOD, APPARATUS AND COMPUTER PROGRAM PRODUCT FOR MANAGING LOST WRITES IN FILE SYSTEMS

(71) Applicant: EMC IP Holding Company LLC, Hopkinton, MA (US)

(72) Inventors: Yaming KUANG, Shanghai (CN); Yunfei CHEN, Shanghai (CN); Xiao Hua FAN, Shanghai (CN); Philippe ARMANGAU, Acton, MA (US)

(73) Assignee: EMC IP Holding Company LLC, Hopkinton, MA (US)

(21) Appl. No.: 16/179,389

(22) Filed: Nov. 2, 2018

(51) Int. Cl. G06F 16/27; G06F 16/174; G06F 16/182; G06F 16/188

(52) U.S. Cl. CPC G06F 16/27; G06F 16/1748; G06F 16/188; G06F 16/184; G06F 16/1744

(57) ABSTRACT

There is disclosed techniques for managing lost writes in file systems. In one embodiment, the techniques detect a virtual block map (VBM) lost write in a deduplication-enabled file system. The VBM lost write resulting in a first VBM being re-allocated such that a first and a second multi-block segment point to the first VBM but the first VBM points to the first segment and not the second segment. The techniques also rebuild a second VBM that points to the second segment. The techniques also determine if a mapping pointer (MP) is a deduplication MP or a non-deduplication MP. The techniques also determine whether to connect the MP to the first VBM or the second VBM.

### TECHNICAL FIELD

The present invention relates generally to file systems. More particularly, the present invention relates to a method, an apparatus and a computer program product for managing lost writes in file systems.

### BACKGROUND OF THE INVENTION

Computer systems may include different resources used by one or more host processors. Resources and host processors in a computer system may be interconnected by one or more communication connections. These resources may include, for example, data storage devices such as those included in the data storage systems manufactured by Dell EMC. These data storage systems may be coupled to one or more servers or host processors and provide storage services to each host processor. Multiple data storage systems from one or more different vendors may be connected and may provide common data storage for one or more host processors in a computer system.

A host processor may perform a variety of data processing tasks and operations using the data storage system. For example, a host processor may perform basic system I/O operations in connection with data requests, such as data read and write operations.

Host processor systems may store and retrieve data using a storage device containing a plurality of host interface units, disk drives, and disk interface units. The host systems access the storage device through a plurality of channels provided therewith. Host systems provide data and access control information through the channels to the storage device and the storage device provides data to the host systems also through the channels. The host systems do not address the disk drives of the storage device directly, but rather, access what appears to the host systems as a plurality of logical disk units. The logical disk units may or may not correspond to the actual disk drives. Allowing multiple host systems to access the single storage device unit allows the host systems to share data in the device. In order to facilitate sharing of the data on the device, additional software on the data storage systems may also be used.

In data storage systems where high-availability is a necessity, system administrators are constantly faced with the challenges of preserving data integrity and ensuring availability of critical system components. One critical system component in any computer processing system is its file system. File systems include software programs and data structures that define the use of underlying data storage devices. File systems are responsible for organizing disk storage into files and directories and keeping track of which part of disk storage belong to which file and which are not being used.

The accuracy and consistency of a file system is necessary to relate applications and data used by those applications. However, there may exist the potential for data corruption in any computer system and therefore measures are taken to periodically ensure that the file system is consistent and accurate. In a data storage system, hundreds of files may be created, modified, and deleted on a regular basis. Each time a file is modified, the data storage system performs a series of file system updates. These updates, when written to a disk storage reliably, yield a consistent file system. However, a file system can develop inconsistencies in several ways. Problems may result from an unclean shutdown, if a system is shut down improperly, or when a mounted file system is taken offline improperly. Inconsistencies can also result from defective hardware or hardware failures. Additionally, inconsistencies can also result from software errors or user errors.

In light of this problem, file systems are monitored to check for consistency. For example, a file system checking (FSCK) utility provides a mechanism to help detect and fix inconsistencies in a file system. The FSCK utility verifies the integrity of the file system and optionally repairs the file system. In general, the primary function of the FSCK utility is to help maintain the integrity of the file system. The FSCK utility verifies the metadata of a file system, recovers inconsistent metadata to a consistent state and thus restores the integrity of the file system.

### SUMMARY OF THE INVENTION

There is disclosed a method, comprising: detecting a virtual block map (VBM) lost write in a deduplication-enabled file system, wherein the VBM lost write results in a first VBM being re-allocated such that a first and a second multi-block segment point to the first VBM but the first VBM points to the first segment and not the second segment; rebuilding a second VBM that points to the second segment; determining if a mapping pointer (MP) is a deduplication MP or a non-deduplication MP; and determining whether to connect the MP to the first VBM or the second VBM.

There is also disclosed an apparatus, comprising: memory; and processing circuitry coupled to the memory, the memory storing instructions which, when executed by the processing circuitry, cause the processing circuitry to: detect a virtual block map (VBM) lost write in a deduplication-enabled file system, wherein the VBM lost write results in a first VBM being re-allocated such that a first and a second multi-block segment point to the first VBM but the first VBM points to the first segment and not the second segment; rebuild a second VBM that points to the second segment; determine if a mapping pointer (MP) is a deduplication MP or a non-deduplication MP; and determine whether to connect the MP to the first VBM or the second VBM.

There is also disclosed a computer program product having a non-transitory computer readable medium which stores a set of instructions, the set of instructions, when carried out by processing circuitry, causing the processing circuitry to perform a method of: detecting a virtual block map (VBM) lost write in a deduplication-enabled file system, wherein the VBM lost write results in a first VBM being re-allocated such that a first and a second multi-block segment point to the first VBM but the first VBM points to the first segment and not the second segment; rebuilding a second VBM that points to the second segment; determining if a mapping pointer (MP) is a deduplication MP or a non-deduplication MP; and determining whether to connect the MP to the first VBM or the second VBM.

### BRIEF DESCRIPTION OF THE DRAWINGS

The invention will be more clearly understood from the following description of preferred embodiments thereof, which are given by way of examples only, with reference to the accompanying drawings, in which:

FIG. 1 is an example computer system that may be used in connection with one or more embodiments;

FIGS. 2 and 3 illustrate in further detail components that may be used in connection with one or more embodiments;

FIG. 4 is a flowchart depicting an example method in connection with one or more embodiments;

FIG. 5 illustrates an exemplary processing platform that may be used to implement at least a portion of one or more embodiments comprising a cloud infrastructure; and

FIG. 6 illustrates another exemplary processing platform that may be used to implement at least a portion of one or more embodiments.

### DETAILED DESCRIPTION

File system lost writes may be caused when write fails to reach disk due to file system software bugs or low level errors such as firmware bugs. For example, in one embodiment, a file system may respond to writing data by allocating a new virtual block map (VBM) and a range of data blocks (multi-block segment) that results in mapping pointers (MPs) in one or more indirect blocks (IBs) pointing to the new VBM and the VMB pointing to the data blocks. However, in the event of a VBM lost write occurring (i.e. the new VBM is not persisted in VBM block finally), the VBM may still be deemed free such that the MPs in the IB blocks point to a free VBM and the data blocks are orphan data blocks. Unfortunately, in this type of scenario, when the file system writes more data, the file system may allocate the VBM again. It should be understood that this re-allocation of the VBM has the potential to lead to a massive data loss.

The above VBM lost write scenario may be exacerbated depending on whether or not inline deduplication is enabled in the file system. For example, without the inline deduplication feature, VBMs are rebuilt based on metadata (file offset) stored in ZipHeaders associated with a multi-block segment pointed to by the VBM plus mapping pointers (MP) disposed within the leaf indirect blocks that are pointing to the VBM and which enable cross checking of the file offset and weight information. However, with the inline deduplication feature, there is a challenge rebuilding the VBM correctly when there is lost write on the VBM. For example, the nature of deduplication results in any MP of arbitrary offset being deduplicated to any MP of another offset. At present, it is not known how to reconnect a rebuilt VBM to MPs as every MP may be a candidate as a reconnectable MP. The current approach to dealing with this issue is to free the segments, the VBM and all the MPs pointing to the VBM which leads to data loss. This is obviously undesirable.

Furthermore, it should be noted that lost write on VBM normally ensures all, for example, 4 KB VBMs are lost instead of a single VBM because the flush is based on 4 KB page in existing file system logic. For example, a 4K VBM block can store about 32 VBMs such that VBM lost write is actually the lost write of a VBM block which may result in the lost write of maximum 32 VBMs.

Described in following paragraphs are techniques that may be used in an embodiment in accordance with the techniques disclosed herein to efficiently manage a VBM lost write in a file system.

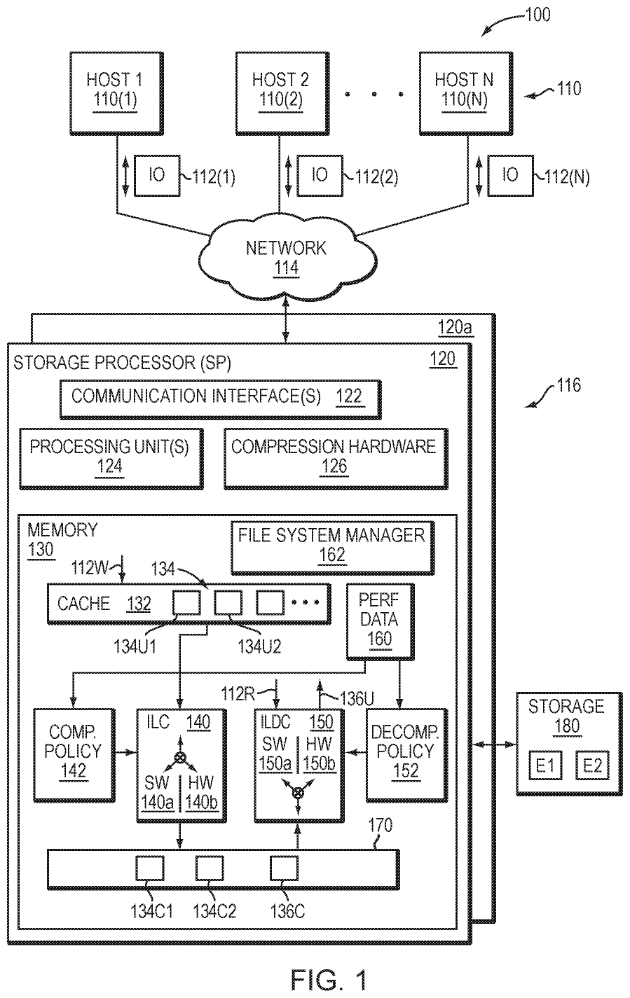

FIG. 1 depicts an example embodiment of a system that may be used in connection with performing the techniques described herein. Here, multiple host computing devices (“hosts”) 110, shown as devices 110(1) through 110(N), access a data storage system 116 over a network 114. The data storage system 116 includes a storage processor, or “SP,” 120 and storage 180. In an example, the storage 180 includes multiple disk drives, such as magnetic disk drives, electronic flash drives, optical drives, and/or other types of drives. Such disk drives may be arranged in RAID (Redundant Array of Independent/Inexpensive Disks) groups, for example, or in any other suitable way.

In an example, the data storage system 116 includes multiple SPs, like the SP 120 (e.g., a second SP, 120a). The SPs may be provided as circuit board assemblies, or “blades,” which plug into a chassis that encloses and cools the SPs. The chassis may have a backplane for interconnecting the SPs, and additional connections may be made among SPs using cables. No particular hardware configuration is required, however, as any number of SPs, including a single SP, may be provided and the SP 120 can be any type of computing device capable of processing host IOs.

The network 114 may be any type of network or combination of networks, such as a storage area network (SAN), a local area network (LAN), a wide area network (WAN), the Internet, and/or some other type of network or combination of networks, for example. The hosts 110(1-N) may connect to the SP 120 using various technologies, such as Fibre Channel, iSCSI, NFS, SMB 3.0, and CIFS, for example. Any number of hosts 110(1-N) may be provided, using any of the above protocols, some subset thereof, or other protocols besides those shown. As is known, Fibre Channel and iSCSI are block-based protocols, whereas NFS, SMB 3.0, and CIFS are file-based protocols. The SP 120 is configured to receive IO (input/output) requests 112(1-N) according to block-based and/or file-based protocols and to respond to such IO requests 112(1-N) by reading and/or writing the storage 180.

As further shown in FIG. 1, the SP 120 includes one or more communication interfaces 122, a set of processing units 124, compression hardware 126, and memory 130. The communication interfaces 122 may be provided, for example, as SCSI target adapters and/or network interface adapters for converting electronic and/or optical signals received over the network 114 to electronic form for use by the SP 120. The set of processing units 124 includes one or more processing chips and/or assemblies. In a particular example, the set of processing units 124 includes numerous multi-core CPUs.

The compression hardware 126 includes dedicated hardware, e.g., one or more integrated circuits, chipsets, sub-assemblies, and the like, for performing data compression and decompression in hardware. The hardware is “dedicated” in that it does not perform general-purpose computing but rather is focused on compression and decompression of data. In some examples, compression hardware 126 takes the form of a separate circuit board, which may be provided as a daughterboard on SP 120 or as an independent assembly that connects to the SP 120 over a backplane, midplane, or set of cables, for example. A non-limiting example of compression hardware 126 includes the Intel® QuickAssist Adapter, which is available from Intel Corporation of Santa Clara, Calif.

The memory 130 includes both volatile memory (e.g., RAM), and non-volatile memory, such as one or more ROMs, disk drives, solid state drives, and the like. The set of processing units 124 and the memory 130 together form control circuitry, which is constructed and arranged to carry out various methods and functions as described herein. Also, the memory 130 includes a variety of software constructs realized in the form of executable instructions. When the executable instructions are run by the set of processing units 124, the set of processing units 124 are caused to carry out the operations of the software constructs. Although certain software constructs are specifically shown and described, it is understood that the memory 130 typically includes many other software constructs, which are not shown, such as an operating system, various applications, processes, and daemons.

As further shown in FIG. 1, the memory 130 “includes,” i.e., realizes by execution of software instructions, a cache 132, an inline compression (ILC) engine 140, an inline decompression (ILDC) engine 150, and a data object 170. A compression policy 142 provides control input to the ILC engine 140, and a decompression policy 152 provides control input to the ILDC engine 150. Both the compression policy 142 and the decompression policy 152 receive performance data 160, which describe a set of operating conditions in the data storage system 116.

In an example, the data object 170 is a host-accessible data object, such as a LUN (Logical UNit), a file system, or a virtual machine disk (e.g., a VVol, available from VMWare, Inc. of Palo Alto, Calif.). The SP 120 exposes the data object 170 to hosts 110 for reading, writing, and/or other data operations. In one particular, non-limiting example, the SP 120 runs an internal file system and implements data object 170 within a single file of that file system. In such an example, the SP 120 includes mapping (not shown) to convert read and write requests from hosts 110 (e.g., IO requests 112(1-N)) to corresponding reads and writes to the file in the internal file system.

As further shown in FIG. 1, ILC engine 140 includes a software component (SW) 140a and a hardware component (HW) 140b. The software component 140a includes a compression method, such as an algorithm, which may be implemented using software instructions. Such instructions may be loaded in memory and executed by processing units 124, or some subset thereof, for compressing data directly, i.e., without involvement of the compression hardware 126. In comparison, the hardware component 140b includes software constructs, such as a driver and API (application programmer interface) for communicating with compression hardware 126, e.g., for directing data to be compressed by the compression hardware 126. In some examples, either or both components 140a and 140b support multiple compression algorithms. The compression policy 142 and/or a user may select a compression algorithm best suited for current operating conditions, e.g., by selecting an algorithm that produces a high compression ratio for some data, by selecting an algorithm that executes at high speed for other data, and so forth.

For decompressing data, the ILDC engine 150 includes a software component (SW) 150a and a hardware component (HW) 150b. The software component 150a includes a decompression algorithm implemented using software instructions, which may be loaded in memory and executed by any of processing units 124 for decompressing data in software, without involvement of the compression hardware 126. The hardware component 150b includes software constructs, such as a driver and API for communicating with compression hardware 126, e.g., for directing data to be decompressed by the compression hardware 126. Either or both components 150a and 150b may support multiple decompression algorithms. In some examples, the ILC engine 140 and the ILDC engine 150 are provided together in a single set of software objects, rather than as separate objects, as shown.

In example operation, hosts 110(1-N) issue IO requests 112(1-N) to the data storage system 116 to perform reads and writes of data object 170. SP 120 receives the IO requests 112(1-N) at communications interface(s) 122 and passes them to memory 130 for further processing. Some IO requests 112(1-N) specify data writes 112W, and others specify data reads 112R. Cache 132 receives write requests 112W and stores data specified thereby in cache elements 134. In a non-limiting example, the cache 132 is arranged as a circular data log, with data elements 134 that are specified in newly-arriving write requests 112W added to a head and with further processing steps pulling data elements 134 from a tail. In an example, the cache 132 is implemented in DRAM (Dynamic Random Access Memory), the contents of which are mirrored between SPs 120 and 120a and persisted using batteries. In an example, SP 120 may acknowledge writes 112W back to originating hosts 110 once the data specified in those writes 112W are stored in the cache 132 and mirrored to a similar cache on SP 120a. It should be appreciated that the data storage system 116 may host multiple data objects, i.e., not only the data object 170, and that the cache 132 may be shared across those data objects.

When the SP 120 is performing writes, the ILC engine 140 selects between the software component 140a and the hardware component 140b based on input from the compression policy 142. For example, the ILC engine 140 is configured to steer incoming write requests 112W either to the software component 140a for performing software compression or to the hardware component 140b for performing hardware compression.

In an example, cache 132 flushes to the respective data objects, e.g., on a periodic basis. For example, cache 132 may flush element 134U1 to data object 170 via ILC engine 140. In accordance with compression policy 142, ILC engine 140 selectively directs data in element 134U1 to software component 140a or to hardware component 140b. In this example, compression policy 142 selects software component 140a. As a result, software component 140a receives the data of element 134U1 and applies a software compression algorithm to compress the data. The software compression algorithm resides in the memory 130 and is executed on the data of element 134U1 by one or more of the processing units 124. Software component 140a then directs the SP 120 to store the resulting compressed data 134C1 (the compressed version of the data in element 134U1) in the data object 170. Storing the compressed data 134C1 in data object 170 may involve both storing the data itself and storing any metadata structures required to support the data 134C1, such as block pointers, a compression header, and other metadata.

It should be appreciated that this act of storing data 134C1 in data object 170 provides the first storage of such data in the data object 170. For example, there was no previous storage of the data of element 134U1 in the data object 170. Rather, the compression of data in element 134U1 proceeds “inline” because it is conducted in the course of processing the first write of the data to the data object 170.

Continuing to another write operation, cache 132 may proceed to flush element 134U2 to data object 170 via ILC engine 140, which, in this case, directs data compression to hardware component 140b, again in accordance with policy 142. As a result, hardware component 140b directs the data in element 134U2 to compression hardware 126, which obtains the data and performs a high-speed hardware compression on the data. Hardware component 140b then directs the SP 120 to store the resulting compressed data 134C2 (the compressed version of the data in element 134U2) in the data object 170. Compression of data in element 134U2 also takes place inline, rather than in the background, as there is no previous storage of data of element 134U2 in the data object 170.

In an example, directing the ILC engine 140 to perform hardware or software compression further entails specifying a particular compression algorithm. The algorithm to be used in each case is based on compression policy 142 and/or specified by a user of the data storage system 116. Further, it should be appreciated that compression policy 142 may operate ILC engine 140 in a pass-through mode, i.e., one in which no compression is performed. Thus, in some examples, compression may be avoided altogether if the SP 120 is too busy to use either hardware or software compression.

In some examples, storage 180 is provided in the form of multiple extents, with two extents E1 and E2 particularly shown. In an example, the data storage system 116 monitors a “data temperature” of each extent, i.e., a frequency of read and/or write operations performed on each extent, and selects compression algorithms based on the data temperature of extents to which writes are directed. For example, if extent E1 is “hot,” meaning that it has a high data temperature, and the data storage system 116 receives a write directed to E1, then compression policy 142 may select a compression algorithm that executes at high speed for compressing the data directed to E1. However, if extent E2 is “cold,” meaning that it has a low data temperature, and the data storage system 116 receives a write directed to E2, then compression policy 142 may select a compression algorithm that executes at high compression ratio for compressing data directed to E2.

When SP 120 performs reads, the ILDC engine 150 selects between the software component 150a and the hardware component 150b based on input from the decompression policy 152 and also based on compatible algorithms. For example, if data was compressed using a particular software algorithm for which no corresponding decompression algorithm is available in hardware, the ILDC engine 150 may steer the compressed data to the software component 150a, as that is the only component equipped with the algorithm needed for decompressing the data. However, if both components 150a and 150b provide the necessary algorithm, then selection among components 150a and 150b may be based on decompression policy 152.

To process a read request 112R directed to compressed data 136C, the ILDC engine 150 accesses metadata of the data object 170 to obtain a header for the compressed data 136C. The compression header specifies the particular algorithm that was used to compress the data 136C. The ILDC engine 150 may then check whether the algorithm is available to software component 150a, to hardware component 150b, or to both. If the algorithm is available only to one or the other of components 150a and 150b, the ILDC engine 150 directs the compressed data 136C to the component that has the necessary algorithm. However, if the algorithm is available to both components 150a and 150b, the ILDC engine 150 may select between components 150a and 150b based on input from the decompression policy 152. If the software component 150a is selected, the software component 150a performs the decompression, i.e., by executing software instructions on one or more of the set of processors 124. If the hardware component 150b is selected, the hardware component 150b directs the compression hardware 126 to decompress the data 136C. The SP 120 then returns the resulting uncompressed data 136U to the requesting host 110.

It should be appreciated that the ILDC engine 150 is not required to use software component 150a to decompress data that was compressed by the software component 140a of the ILC engine 140. Nor is it required that the ILDC engine 150 use hardware component 150b to decompress data that was compressed by the hardware component 140b. Rather, the component 150a or 150b may be selected flexibly as long as algorithms are compatible. Such flexibility may be especially useful in cases of data migration. For example, consider a case where data object 170 is migrated to a second data storage system (not shown). If the second data storage system does not include compression hardware 126, then any data compressed using hardware on data storage system 116 may be decompressed on the second data storage system using software.

With the arrangement of FIG. 1, the SP 120 intelligently directs compression and decompression tasks to software or to hardware based on operating conditions in the data storage system 116. For example, if the set of processing units 124 are already busy but the compression hardware 126 is not, the compression policy 142 can direct more compression tasks to hardware component 140b. Conversely, if compression hardware 126 is busy but the set of processing units 124 are not, the compression policy 142 can direct more compression tasks to software component 140a. Decompression policy 152 may likewise direct decompression tasks based on operating conditions, at least to the extent that direction to hardware or software is not already dictated by the algorithm used for compression. In this manner, the data storage system 116 is able to perform inline compression using both hardware and software techniques, leveraging the capabilities of both while applying them in proportions that result in best overall performance.

In such an embodiment in which element 120 of FIG. 1 is implemented using one or more data storage systems, each of the data storage systems may include code thereon for performing the techniques as described herein.

Servers or host systems, such as 110(1)-110(N), provide data and access control information through channels to the storage systems, and the storage systems may also provide data to the host systems also through the channels. The host systems may not address the disk drives of the storage systems directly, but rather access to data may be provided to one or more host systems from what the host systems view as a plurality of logical devices or logical volumes (LVs). The LVs may or may not correspond to the actual disk drives. For example, one or more LVs may reside on a single physical disk drive. Data in a single storage system may be accessed by multiple hosts allowing the hosts to share the data residing therein. An LV or LUN (logical unit number) may be used to refer to the foregoing logically defined devices or volumes.

The data storage system may be a single unitary data storage system, such as single data storage array, including two storage processors or compute processing units. Techniques herein may be more generally use in connection with any one or more data storage system each including a different number of storage processors than as illustrated herein. The data storage system 116 may be a data storage array, such as a Unity™, a VNX™ or VNXe™ data storage array by Dell EMC of Hopkinton, Mass., including a plurality of data storage devices 116 and at least two storage processors 120a. Additionally, the two storage processors 120a may be used in connection with failover processing when communicating with a management system for the storage system. Client software on the management system may be used in connection with performing data storage system management by issuing commands to the data storage system 116 and/or receiving responses from the data storage system 116 over a connection. In one embodiment, the management system may be a laptop or desktop computer system.

The particular data storage system as described in this embodiment, or a particular device thereof, such as a disk, should not be construed as a limitation. Other types of commercially available data storage systems, as well as processors and hardware controlling access to these particular devices, may also be included in an embodiment.

In some arrangements, the data storage system 116 provides block-based storage by storing the data in blocks of logical storage units (LUNs) or volumes and addressing the blocks using logical block addresses (LBAs). In other arrangements, the data storage system 116 provides file-based storage by storing data as files of a file system and locating file data using inode structures. In yet other arrangements, the data storage system 116 stores LUNs and file systems, stores file systems within LUNs, and so on.

As further shown in FIG. 1, the memory 130 includes a file system and a file system manager 162. A file system is implemented as an arrangement of blocks, which are organized in an address space. Each of the blocks has a location in the address space, identified by FSBN (file system block number). Further, such address space in which blocks of a file system are organized may be organized in a logical address space where the file system manager 162 further maps respective logical offsets for respective blocks to physical addresses of respective blocks at specified FSBNs. In some cases, data to be written to a file system are directed to blocks that have already been allocated and mapped by the file system manager 162, such that the data writes prescribe overwrites of existing blocks. In other cases, data to be written to a file system do not yet have any associated physical storage, such that the file system must allocate new blocks to the file system to store the data. Further, for example, FSBN may range from zero to some large number, with each value of FSBN identifying a respective block location. The file system manager 162 performs various processing on a file system, such as allocating blocks, freeing blocks, maintaining counters, and scavenging for free space.

In at least one embodiment of the current technique, an address space of a file system may be provided in multiple ranges, where each range is a contiguous range of FSBNs and is configured to store blocks containing file data. In addition, a range includes file system metadata, such as inodes, indirect blocks (IBs), and virtual block maps (VBMs), for example. As is known, inodes are metadata structures that store information about files and may include pointers to IBs. IBs include pointers that point either to other IB s or to data blocks. IBs may be arranged in multiple layers, forming IB trees, with leaves of the IB trees including block pointers that point to data blocks. Together, the leaf IB's of a file define the file's logical address space, with each block pointer in each leaf IB specifying a logical address into the file. Virtual block maps (VBMs) are structures placed between block pointers of leaf IBs and respective data blocks to provide data block virtualization. The term “VBM” as used herein describes a metadata structure that has a location in a file system that can be pointed to by other metadata structures in the file system and that includes a block pointer to another location in a file system, where a data block or another VBM is stored. However, it should be appreciated that data and metadata may be organized in other ways, or even randomly, within a file system. The particular arrangement described above herein is intended merely to be illustrative.

Further, in at least one embodiment of the current technique, ranges associated with an address space of a file system may be of any size and of any number. In some examples, the file system manager 162 organizes ranges in a hierarchy. For instance, each range may include a relatively small number of contiguous blocks, such as 16 or 32 blocks, for example, with such ranges provided as leaves of a tree. Looking up the tree, ranges may be further organized in CG (cylinder groups), slices (units of file system provisioning, which may be 256 MB or 1 GB in size, for example), groups of slices, and the entire file system, for example. Although ranges 154 as described above herein apply to the lowest level of the tree, the term “ranges” as used herein may refer to groupings of contiguous blocks at any level.

In at least one embodiment of the technique, hosts 110(1-N) issue IO requests 112(1-N) to the data storage system 116. The SP 120 receives the IO requests 112(1-N) at the communication interfaces 122 and initiates further processing. Such processing may include, for example, performing read and write operations on a file system, creating new files in the file system, deleting files, and the like. Over time, a file system changes, with new data blocks being allocated and allocated data blocks being freed. In addition, the file system manager 162 also tracks freed storage extents. In an example, storage extents are versions of block-denominated data, which are compressed down to sub-block sizes and packed together in multi-block segments. Further, a file system operation may cause a storage extent in a range to be freed e.g., in response to a punch-hole or write-split operation. Further, a range may have a relatively large number of freed fragments but may still be a poor candidate for free-space scavenging if it has a relatively small number of allocated blocks. With one or more candidate ranges identified, the file system manager 162 may proceed to perform free-space scavenging on such range or ranges. Such scavenging may include, for example, liberating unused blocks from segments (e.g., after compacting out any unused portions), moving segments from one range to another to create free space, and coalescing free space to support contiguous writes and/or to recycle storage resources by returning such resources to a storage pool. Thus, file system manager 162 may scavenge free space, such as by performing garbage collection, space reclamation, and/or free-space coalescing.

Additionally, in at least one embodiment, the memory 130 “includes,” i.e., realizes by execution of software instructions, a deduplication engine 150. The deduplication engine 150 optionally performs deduplication by determining if a first allocation unit of data in the storage system matches a second allocation unit of data. When a match is found, the leaf pointer for the first allocation unit is replaced with a deduplication pointer to the leaf pointer of the second allocation unit. It should be understood that this is only one approach to deduplication. For example, in other embodiments, the deduplication MP may point to a VBM extent directly as will be explained further below.

For additional details regarding compression and deduplication, see, for example, U.S. patent application Ser. No. 15/393,331, filed Dec. 29, 2016, entitled “Managing Inline Data Compression in Storage Systems,” (Attorney Docket No. EMC-16-0800), U.S. patent application Ser. No. 15/664,253, filed Jul. 31, 2017, entitled “Data Reduction Reporting in Storage Systems,” (Attorney Docket No. 108952), U.S. patent application Ser. No. 16/054,216, filed Aug. 3, 2018, entitled “Method, Apparatus and Computer Program Product for Managing Data Storage,” (Attorney Docket No. 110348), U.S. patent application Ser. No. 16/054,301, filed Aug. 3, 2018, entitled “Method, Apparatus and Computer Program Product for Managing Data Storage,” (Attorney Docket No. 111354), all of which are incorporated by reference herein in their entirety.

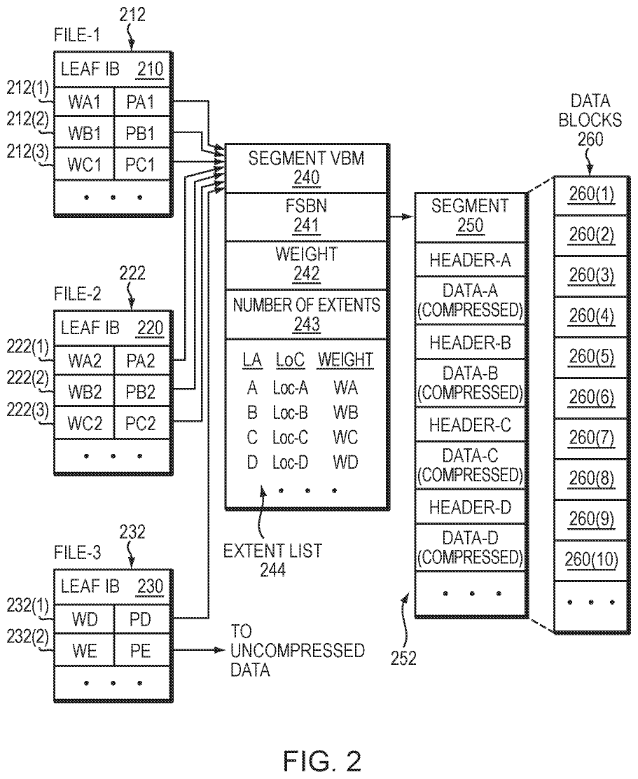

Referring to FIG. 2, shown is more detailed representation of components that may be included in an embodiment using the techniques herein. As shown in FIG. 2, a segment 250 that stores data of a file system is composed from multiple data blocks 260. Here, segment 250 is made up of at least ten data blocks 260(1) through 260(10); however, the number of data blocks per segment may vary. In an example, the data blocks 260 are contiguous, meaning that they have consecutive FSBNs in a file system address space for the file system. Although segment 250 is composed from individual data blocks 260, the file system treats the segment 250 as one continuous space. Compressed storage extents 252, i.e., Data-A through Data-D, etc., are packed inside the segment 250. In an example, each of storage extents 252 is initially a block-sized set of data, which has been compressed down to a smaller size. An 8-block segment may store the compressed equivalent of 12 or 16 blocks or more of uncompressed data, for example. The amount of compression depends on the compressibility of the data and the particular compression algorithm used. Different compressed storage extents 252 typically have different sizes. Further, for each storage extent 252 in the segment 250, a corresponding weight is maintained, the weight arranged to indicate whether the respective storage extent 252 is currently part of any file in a file system by indicating whether other block pointers in the file system point to that block pointer.

The segment 250 has an address (e.g., FSBN 241) in the file system, and a segment VBM (Virtual Block Map) 240 points to that address. For example, segment VBM 240 stores a segment pointer 241, which stores the FSBN of the segment 250. By convention, the FSBN of segment 250 may be the FSBN of its first data block, i.e., block 260(1). Although not shown, each block 260(1)-260(10) may have its respective per-block metadata (BMD), which acts as representative metadata for the respective, block 260(1)-260(10), and which includes a backward pointer to the segment VBM 240.

As further shown in FIG. 2, the segment VBM 240 stores information regarding the number of extents 243 in the segment 250 and an extent list 244. The extent list 244 acts as an index into the segment 250, by associating each compressed storage extent 252, identified by logical address (e.g., LA values A through D, etc.), with a corresponding location within the segment 250 (e.g., Loc values Loc-A through Loc-D, etc., which indicate physical offsets) and a corresponding weight (e.g., Weight values WA through WD, etc.). The weights provide indications of whether the associated storage extents are currently in use by any files in the file system. For example, a positive number for a weight may indicate that at least one file in the file system 150 references the associated storage extent 252. Conversely, a weight of zero may mean that no file in the file system currently references that storage extent 252. It should be appreciated, however, that various numbering schemes for reference weights may be used, such that positive numbers could easily be replaced with negative numbers and zero could easily be replaced with some different baseline value. The particular numbering scheme described herein is therefore intended to be illustrative rather than limiting.

In an example, the weight (e.g., Weight values WA through WD, etc.) for a storage extent 252 reflects a sum, or “total distributed weight,” of the weights of all block pointers in the file system that point to the associated storage extent. In addition, the segment VBM 240 may include an overall weight 242, which reflects a sum of all weights of all block pointers in the file system that point to extents tracked by the segment VBM 240. Thus, in general, the value of overall weight 242 should be equal to the sum of all weights in the extent list 242.

Various block pointers 212, 222, and 232 are shown to the left in FIG. 2. In an example, each block pointer is disposed within a leaf IB (Indirect Block), which performs mapping of logical addresses for a respective file to corresponding physical addresses in the file system. Here, leaf IB 210 is provided for mapping data of a first file (F1) and contains block pointers 212(1) through 212(3). Also, leaf IB 220 is provided for mapping data of a second file (F2) and contains block pointers 222(1) through 222(3). Further, leaf IB 230 is provided for mapping data of a third file (F3) and contains block pointers 232(1) and 232(2). Each of leaf IBs 210, 220, and 230 may include any number of block pointers, such as 1024 block pointers each; however, only a small number are shown for ease of illustration. Although a single leaf IB 210 is shown for file-1, the file-1 may have many leaf IB s, which may be arranged in an IB tree for mapping a large logical address range of the file to corresponding physical addresses in a file system to which the file belongs. A “physical address” is a unique address within a physical address space of the file system.

Each of block pointers 212, 222, and 232 has an associated pointer value and an associated weight. For example, block pointers 212(1) through 212(3) have pointer values PA1 through PC1 and weights WA1 through WC1, respectively, block pointers 222(1) through 222(3) have pointer values PA2 through PC2 and weights WA2 through WC2, respectively, and block pointers 232(1) through 232(2) have pointer values PD through PE and weights WD through WE, respectively.

Regarding files F1 and F2, pointer values PA1 and PA2 point to segment VBM 240 and specify the logical extent for Data-A, e.g., by specifying the FSBN of segment VBM 240 and an offset that indicates an extent position. In a like manner, pointer values PB1 and PB2 point to segment VBM 240 and specify the logical extent for Data-B, and pointer values PC1 and PC2 point to segment VBM 240 and specify the logical extent for Data-C. It can thus be seen that block pointers 212 and 222 share compressed storage extents Data-A, Data-B, and Data-C. For example, files F1 and F2 may be snapshots in the same version set. Regarding file F3, pointer value PD points to Data-D stored in segment 250 and pointer value PE points to Data-E stored outside the segment 250. File F3 does not appear to have a snapshot relationship with either of files F1 or F2. If one assumes that data block sharing for the storage extents 252 is limited to that shown, then, in an example, the following relationships may hold:

WA=WA1+WA2;

WB=WB1+WB2;

WC=WC1+WC2;

WD=WD; and

Weight 242=ΣWi (for i=a through d, plus any additional extents 252 tracked by extent list 244).

The detail shown in segment 450 indicates an example layout 252 of data items. In at least one embodiment of the current technique, each compression header is a fixed-size data structure that includes fields for specifying compression parameters, such as compression algorithm, length, CRC (cyclic redundancy check), and flags. In some examples, the header specifies whether the compression was performed in hardware or in software. Further, for instance, Header-A can be found at Loc-A and is immediately followed by compressed Data-A. Likewise, Header-B can be found at Loc-B and is immediately followed by compressed Data-B. Similarly, Header-C can be found at Loc-C and is immediately followed by compressed Data-C.

For performing writes, the ILC engine 140 generates each compression header (Header-A, Header-B, Header-C, etc.) when performing compression on data blocks 260, and directs a file system to store the compression header together with the compressed data. The ILC engine 140 generates different headers for different data, with each header specifying a respective compression algorithm. For performing data reads, a file system looks up the compressed data, e.g., by following a pointer 212, 222, 232 in the leaf IB 210, 220, 230 to the segment VBM 240, which specifies a location within the segment 250. A file system reads a header at the specified location, identifies the compression algorithm that was used to compress the data, and then directs the ILDC 150 to decompress the compressed data using the specified algorithm.

In at least one embodiment of the current technique, for example, upon receiving a request to overwrite and/or update data of data block (Data-D) pointed to by block pointer 232(a), a determination is made as to whether the data block (Data-D) has been shared among any other file. Further, a determination is made as to whether the size of the compressed extent (also referred to herein as “allocation unit”) storing contents of Data-D in segment 250 can accommodate the updated data. Based on the determination, the updated data is written in a compressed format to the compressed extent for Data-D in the segment 250 instead of allocating another allocation unit in a new segment.

Having described certain embodiments, numerous alternative embodiments or variations can be made. For example, although particular metadata structures, such as segment VBMs and block pointers, have been shown and described, these are merely examples. Alternatively, other metadata structures may be employed for accomplishing similar results.

Also, although the segment VBM 240 as shown and described includes an extent list 244, this is merely an example. Alternatively, the extent list 244 or a similar list may be provided elsewhere, such as in the segment 250 itself (e.g., as a header).

Further, although the segment VBM 240 provides block virtualization, nothing prevents there from being additional or different block virtualization structures, or additional levels of block virtualization.

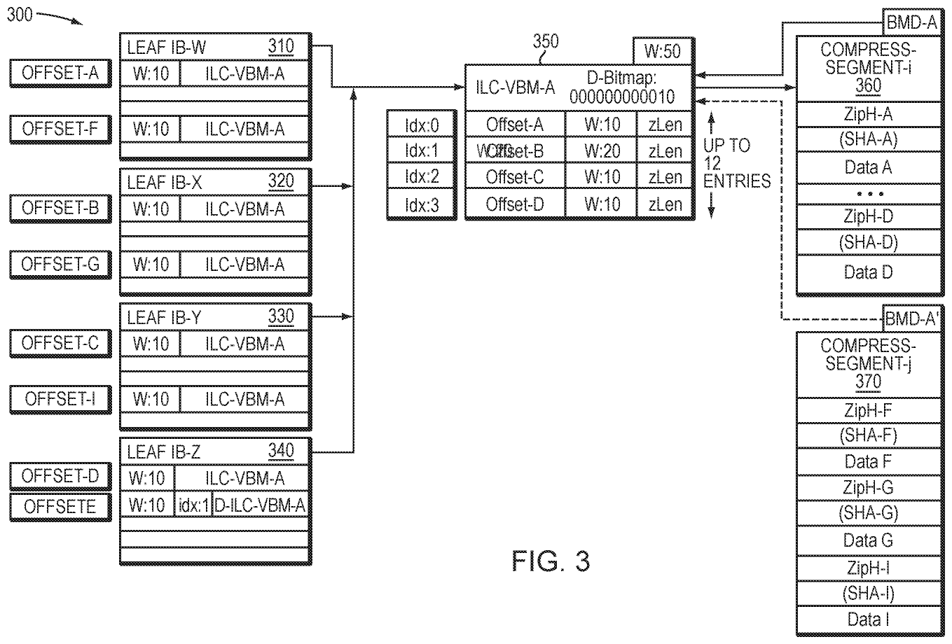

Turning now to FIG. 3, the figure illustrates in further detail components that may be used in connection with one or more embodiments. The figure 300 illustrates a relationship between IBs (310-340), VBM 350 and compressed segments (360-370) in a VBM lost write scenario. In this particular embodiment, the IB 340 includes a deduplication MP (D-ILC) at offset-E and the other IBs (310-330) include compression MPs (ILC) at offsets A, B, C and D. The VBM 350 also includes corresponding offsets A, B, C, D but not offset E. It should be understood that offset-E has the same content as offset-B so deduplication is performed such that offset-E references index 1 (idx:1) in VBM. The figure 300 also illustrates a compressed data segment i 360 and a compressed segment j 370 pointing via their respective BMD back to the same VBM-A due to the VBM lost write scenario. However, the VBM-A is not pointing to compressed-segment-j 370. The VBM-A is pointing to compressed-segment-i 360 only.

Additionally, in the VBM lost write scenario discussed above, it should be understood that there will be two sets of MPs disposed in leaf IBs pointing to VBM-A due to the lost write (i.e., one set as described above and another set including MPs at offsets F, G and I). For example, a first set of MPs should actually be pointing to VBM-A′ whose write was lost (never reached disk). And, a later allocation of VBM got the free VBM on the same slot and a second set of MPs got pointing to this VBM-A (re-allocated on same position of the lost one). For example, in the figure 300, BMD-A bounds to segment i while BMD-A′ bounds to segment j. It should be understood that in this particular example some data is initially written such that ILC-VBM-A is allocated and data is written into compression segment-j. If there were no issue, the ILC-VBM-A should point to segment-j and BMD-A′ should point to ILC-VBM-A. But, in the VBM lost write, ILC-VBM-A is still empty and in an unallocated state. As a result, in this example, when a new write operation comes and wants to allocate a VBM, the ILC-VBM-A is empty so it is allocated. Now, ILC-VBM-A is written with information for this new write operation and is paired with segment-i and BMD-A. The segment-j and BMD-A′ are still assuming they own ILC-VBM-A but actually ILC-VBM-A is pairing with segment-i and BMD-A.

The techniques described herein look into the nature of this lost write behavior and rebuilds as much as possible based on what information is stored in the two compressed regions and MPs in leaf IB. Below describes the methods in FSCK rebuild steps:

### VBM Rebuild Phase:

1. Detect compressed segment A and compressed segment A′ both pointing back to VBM-A (N.B., the terms compressed segments A and A′ are sometimes used herein to refer to compressed segments i and j with BMD-A and BMD-A′, respectfully). For example, in at least one embodiment, this may involve a first and a second step. The first step may comprise pairing the VBM and a compressed segment by browsing all non-free VBMs. It should be understood that a VBM.mp1 field may point to compressed segment's first BMD and this BMD may also point back to VBM. The FSCK may also verify other fields to ensure the VBM and the compressed segment is a good pair. The second step may comprise browsing all non-free compressed segments which are not verified yet. It should be understood that after VBM pair phase all paired compressed segments are marked as verified. The second step may involve identifying the compressed segment that is not paired.
2. Rebuild VBM-A′ based on Zip Header stored in compressed segment A′. For example, FSCK may allocate a new VBM-A′ and rebuild it from segment-A′. Each segment contains zipheaders comprising information relating to the compressed data that can be used to rebuild the VBM. For example, the information may include file offset, zlen (the size of data after compression), etc.

3. Create in memory VBM shadow mapping from VBM-A to VBM-A′ which will be used in phase 1v below.

Phase 1v—IB-Tree Traversal:
For a MP being visited, if it points to VBM-A:
1. If this MP is non-deduplication MP (VBM type: 0x2):
   a. Get replicaID for this MP's hosting leaf IB's BMD, compare it with replicaID stored in VBM header for both A and A′ (N.B., replicaID is an integer value stored in IB (actually in the BMD of IB), VBM and compress segment (in BMD). So the replicaID of ILC-VBM-A′ comes from compress-segment-j, and replicaID is monotonic in that it descends from left to right, which means IB must>=VBM. If not, it's invalid):
      If MP-replicaID<VBM-A-replicaID, exclude VBM-A for connection.
      If MP-replicaID<VBM-A′-replicaID, exclude VBM-A′ for connection.
      If both a && b are true, mark this MP as bad.
   b. If MP's offset could be found in both VBM-A and A′ extents:
      If weight of the extent in A is zero, connect this MP to A′
      Else mark this MP as bad.
   c. If MP's offset could not be found in neither VBM-A nor A′ extents, mark this MP as bad.
   d. If MP's offset could only be found in either VBM-A or A′, connect to VBM-A or A′s extent accordingly:
      If offset is found in A, if weight is zero, mark this MP as BAD, else connect this MP to A.
      If offset is found in A′, connect this MP to A′.
2. If this MP is deduplication MP, look at the “extent idx” in MP:
   a. If A.extent[idx].zlen==0 && A′.extent[idx].zlen==0, mark this MP as bad.
   b. If A.extent[idx].zlen>0 && A′.extents[idx].zlen==0, exclude VBM-A′for connection.
   c. If A.extent[idx].zlen==0 && A′.extents[idx].zlen>0, exclude VBM-A for connection.
   d. If A.extent[idx].zlen>0 && A.extent[idx].weight==0 && A.d_bitmap[idx]==1 && A′.extent[idx].zlen==0
      Connect MP to VBM-A
   e. If A.extent[idx].zlen==0 && A′.extent[idx].zlen>0
      Connect MP to VBM-A′
   f. If A.extent[idx].zlen>0 && A.extent[idx].weight==0 && A′.extent[idx].zlen>0
      Connect MP to VBM-A′
   g. If A.extent[idx].zlen>0 && A.extent[idx].d_bitmap[idx]==0 && A′.extent[idx].zlen>0
      Connect MP to VBM-A′
   h. All other cases, mark MP as BAD.

In summary, if the MP is a deduplication MP above, FSCK will check if deduplication MP with “extent idx” pointing to A.extent[idx] is possibly correct and check if deduplication MP with “extent idx” pointing to A′.extent[idx] is possibly correct:
1. if both are correct, FSCK cannot make decision, just mark the MP as bad.
2. if only one is correct, FSCK will make MP pointing to the correct extent in VBM-A or VBM-A′.
3. if neither is correct, FSCK will make MP as bad.
   The checking rules include:

For VBM-A, which is primary VBM, check idx^{th} extent's zlen, weight and d_bitmap (which represent if the corresponding compressed data has ever been deduplicated)
1. if A.extent[idx].zlen=0, it's an extent having no valid compressed data, and deduplication MP cannot point to this extent
2. if A.extent[idx].weight=0, it's an extent having a free compressed data, and deduplication MP cannot point to this extent
3. if A.d_bitmap[idx]==0, it's an extent having a compressed data which has never been deduplicated, and deduplication MP cannot point to this extent.

For VBM-A′, which is shadow VBM rebuilt from zipheaders associated with compressed segment, check only idx^{th} extent's zlen as weight and d_bitmap information were lost during rebuilding VBM.
1. if A.extent[idx].zlen=0, it's an extent having no valid compressed data, and deduplication MP cannot point to this extent

It should be noted that in 2a above neither are correct so the MP is marked as bad. Further, it be noted that in 2b above both are correct so the MP is marked as bad. Further, it should be noted that in 2c above only extent in VBM-A is correct so mark MP pointing to the extent in VBM-A. Further, it should be noted that in 2d above only extent in VBM-A′ is correct so mark MP pointing to the extent in VBM-A′. Further, it should be noted that in 2e above only extent in VBM-A′ is correct so mark MP pointing to the extent in VBM-A′. Further, it should be noted that in 2f above only extent in VBM-A′ is correct, mark MP pointing to the extent in VBM-A′. Further, it should be noted that in 2g above neither are correct so mark as bad. Further, it should be noted in 2h that for all other cases mark as bad.

Advantageously, the techniques rebuild the lost write VBM and pair each VBM to its compressed data segment. The techniques also pair those non-deduplication MPs to the correct VBM (the one re-allocated and the one newly rebuilt). The techniques also pair the deduplication MPs by applying certain checks which can rebuild them as much as possible.

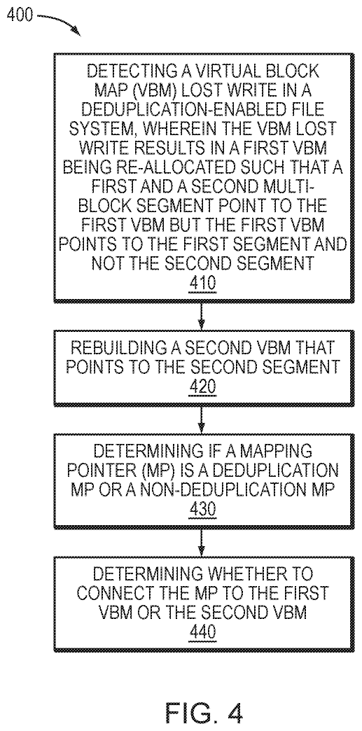

FIG. 4 shows an example method 400 that may be carried out in connection with the system 100. The method 400 typically performed, for example, by the software constructs described in connection with FIG. 1, which reside in the memory 130 of the storage processor 120 and are run by the processing unit(s) 124. The various acts of method 400 may be ordered in any suitable way. Accordingly, embodiments may be constructed in which acts are performed in orders different from that illustrated, which may include performing some acts simultaneously.

At step 410, detecting a virtual block map (VBM) lost write in a deduplication-enabled file system, wherein the VBM lost write results in a first VBM being re-allocated such that a first and a second multi-block segment point to the first VBM but the first VBM points to the first segment and not the second segment. At step 420, rebuilding a second VBM that points to the second segment. At step 430, determining if a mapping pointer (MP) is a deduplication MP or a non-deduplication MP. At step 440, determining whether to connect the MP to the first VBM or the second VBM.

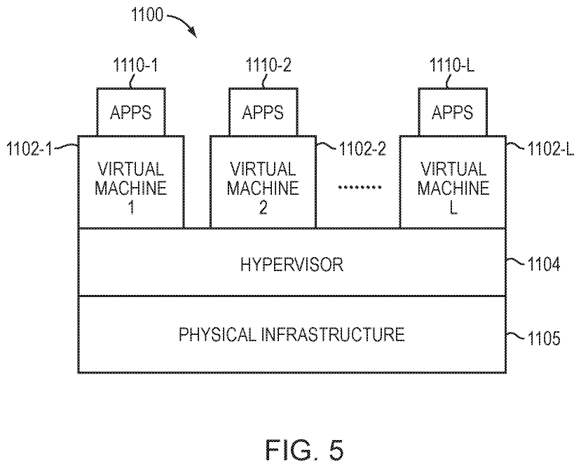

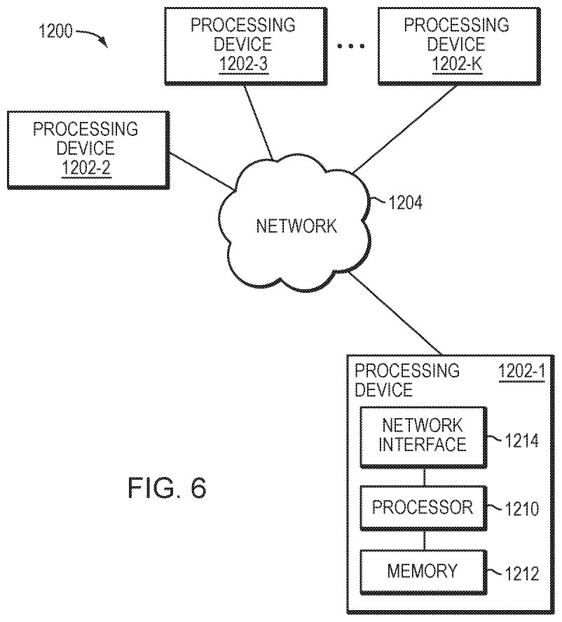

Illustrative embodiments of processing platforms will now be described in greater detail with reference to FIGS. 5 and 6. These platforms may also be used to implement at least portions of other information processing systems in other embodiments.

Referring now to FIG. 5, one possible processing platform that may be used to implement at least a portion of one or more embodiments of the disclosure comprises cloud infrastructure 1100. The cloud infrastructure 1100 in this exemplary processing platform comprises virtual machines (VMs) 1102-1, 1102-2, . . . 1102-L implemented using a hypervisor 1104. The hypervisor 1104 runs on physical infrastructure 1105. The cloud infrastructure 1100 further comprises sets of applications 1110-1, 1110-2, . . . 1110-L running on respective ones of the virtual machines 1102-1, 1102-2, . . . 1102-L under the control of the hypervisor 1104.

The cloud infrastructure 1100 may encompass the entire given system or only portions of that given system, such as one or more of client, servers, controllers, or computing devices in the system.

Although only a single hypervisor 1104 is shown in the embodiment of FIG. 5, the system may of course include multiple hypervisors each providing a set of virtual machines using at least one underlying physical machine. Different sets of virtual machines provided by one or more hypervisors may be utilized in configuring multiple instances of various components of the system.

An example of a commercially available hypervisor platform that may be used to implement hypervisor 1104 and possibly other portions of the system in one or more embodiments of the disclosure is the VMware® vSphere™ which may have an associated virtual infrastructure management system, such as the VMware® vCenter™. As another example, portions of a given processing platform in some embodiments can comprise converged infrastructure such as VxRail™, VxRack™, VxBlock™, or Vblock® converged infrastructure commercially available from VCE, the Virtual Computing Environment Company, now the Converged Platform and Solutions Division of Dell EMC of Hopkinton, Mass. The underlying physical machines may comprise one or more distributed processing platforms that include storage products, such as VNX™ and Symmetrix VMAX™, both commercially available from Dell EMC. A variety of other storage products may be utilized to implement at least a portion of the system.

In some embodiments, the cloud infrastructure additionally or alternatively comprises a plurality of containers implemented using container host devices. For example, a given container of cloud infrastructure illustratively comprises a Docker container or other type of LXC. The containers may be associated with respective tenants of a multi-tenant environment of the system, although in other embodiments a given tenant can have multiple containers. The containers may be utilized to implement a variety of different types of functionality within the system. For example, containers can be used to implement respective compute nodes or cloud storage nodes of a cloud computing and storage system. The compute nodes or storage nodes may be associated with respective cloud tenants of a multi-tenant environment of system. Containers may be used in combination with other virtualization infrastructure such as virtual machines implemented using a hypervisor.

As is apparent from the above, one or more of the processing modules or other components of the disclosed systems may each run on a computer, server, storage device or other processing platform element. A given such element may be viewed as an example of what is more generally referred to herein as a “processing device.” The cloud infrastructure 1100 shown in FIG. 5 may represent at least a portion of one processing platform.

Another example of a processing platform is processing platform 1200 shown in FIG. 6. The processing platform 1200 in this embodiment comprises at least a portion of the given system and includes a plurality of processing devices, denoted 1202-1, 1202-2, 1202-3, . . . 1202-K, which communicate with one another over a network 1204. The network 1204 may comprise any type of network, such as a wireless area network (WAN), a local area network (LAN), a satellite network, a telephone or cable network, a cellular network, a wireless network such as WiFi or WiMAX, or various portions or combinations of these and other types of networks.

The processing device 1202-1 in the processing platform 1200 comprises a processor 1210 coupled to a memory 1212. The processor 1210 may comprise a microprocessor, a microcontroller, an application specific integrated circuit (ASIC), a field programmable gate array (FPGA) or other type of processing circuitry, as well as portions or combinations of such circuitry elements, and the memory 1212, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1202-1 is network interface circuitry 1214, which is used to interface the processing device with the network 1204 and other system components, and may comprise conventional transceivers.

The other processing devices 1202 of the processing platform 1200 are assumed to be configured in a manner similar to that shown for processing device 1202-1 in the figure.

Again, the particular processing platform 1200 shown in the figure is presented by way of example only, and the given system may include additional or alternative processing platforms, as well as numerous distinct processing platforms in any combination, with each such platform comprising one or more computers, storage devices or other processing devices.

Multiple elements of system may be collectively implemented on a common processing platform of the type shown in FIG. 5 or 6, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure such as VxRail™, VxRack™, VxBlock™, or Vblock® converged infrastructure commercially available from VCE, the Virtual Computing Environment Company, now the Converged Platform and Solutions Division of Dell EMC.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device.

It should again be emphasized that the above-described embodiments are presented for purposes of illustration only. Many variations and other alternative embodiments may be used. For example, the disclosed techniques are applicable to a wide variety of other types of information processing systems and compute services platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
detecting a virtual block map (VBM) lost write in a deduplication-enabled file system, wherein the VBM lost write results in a first VBM being re-allocated such that a first and a second multi-block segment point to the first VBM but the first VBM points to the first segment and not the second segment;
rebuilding a second VBM that points to the second segment;
determining if a mapping pointer (MP) is a deduplication MP or a non-deduplication MP; and
determining whether to connect the MP to the first VBM or the second VBM.

2. The method as claimed in claim 1, wherein the MP is determined to be a non-deduplication MP; and wherein
determining whether to connect the MP to the first VBM or the second VBM, comprises:
comparing a first replicaID for the MP and a second replicaID for the first VBM such that the MP is excluded from connection to the first VBM if the first replicaID is less than the second replicaID;
comparing the first replicaID for the MP and a third replicaID for the second VBM such that the MP is excluded from connection to the second VBM if the first replicaID is less than the third replicaID; and
marking the MP as bad in the event that the first replicaID is less than both the second and the third replicaID.

3. The method as claimed in claim 1, wherein the MP is determined to be a non-deduplication MP; and wherein
determining whether to connect the MP to the first VBM or the second VBM, comprises:
determining that the offset of the MP is found in both the first and the second VBM;
connecting the MP to the second VBM if a weight associated with the extent in the first VBM indicates that the extent is currently not part of a file in the file system; and
marking the MP as bad if the weight associated with the extent in the first VBM indicates that the extent is currently part of a file in the file system.

4. The method as claimed in claim 1, wherein the MP is determined to be a non-deduplication MP; and wherein
determining whether to connect the MP to the first VBM or the second VBM, comprises:
determining that the offset of the MP is not found in both the first and the second VBM; and
marking the MP as bad based on the said determination.

5. The method as claimed in claim 1, wherein the MP is determined to be a non-deduplication MP; and wherein
determining whether to connect the MP to the first VBM or the second VBM, comprises:
determining that the offset of the MP is found in the first VBM;
marking the MP as bad if a weight associated with the extent in the first VBM indicates that the extent is currently not part of a file in the file system; and
connecting the MP to the first VBM if the weight associated with the extent in the first VBM indicates that the extent is currently part of a file in the file system.

6. The method as claimed in claim 1, wherein the MP is determined to be a non-deduplication MP; and wherein
determining whether to connect the MP to the first VBM or the second VBM, comprises:
determining that the offset of the MP is found in the second VBM; and
connecting the MP to the second VBM based on the said determination.

7. The method as claimed in claim 1, wherein the MP is determined to be a deduplication MP; and wherein
determining whether to connect the MP to the first VBM or the second VBM, comprises:
determining that an extent index associated with the deduplication MP corresponds to an extent index associated with the first and the second VBM; and
marking the deduplication MP as bad based on the said determination.

8. The method as claimed in claim 7, wherein determining that the extent index associated with the deduplication MP corresponds to the extent index associated with the first VBM based on a zLen associated with the extent in the first VBM describing a length of a compressed area in the first segment, a weight associated with the extent in the first VBM that indicates if the extent is currently part of a file in the file system, and a d_bitmap indicating if the extent in the first VBM is associated with deduplication.

9. The method as claimed in claim 7, wherein determining that the extent index associated with the deduplication MP corresponds to the extent index associated with the second VBM based on zLen associated with the extent in the second VBM describing a length of a compressed area in the second segment.

10. The method as claimed in claim 1, wherein the MP is determined to be a deduplication MP; and wherein
determining whether to connect the MP to the first VBM or the second VBM, comprises:
determining that an extent index associated with the deduplication MP does not correspond to an extent index associated with the first and the second VBM; and
marking the deduplication MP as bad based on the said determination.

11. The method as claimed in claim 1, wherein the MP is determined to be a deduplication MP; and wherein
determining whether to connect the MP to the first VBM or the second VBM, comprises:
determining that an extent index associated with the deduplication MP corresponds to an extent index associated with one of the first and the second VBM but not the other of the first and the second VBM; and
connecting the deduplication MP to appropriate extent of the one of the first and the second VBM based on the said determination.

12. An apparatus, comprising:
memory; and
processing circuitry coupled to the memory, the memory storing instructions which, when executed by the processing circuitry, cause the processing circuitry to:
detect a virtual block map (VBM) lost write in a deduplication-enabled file system, wherein the VBM lost write results in a first VBM being re-allocated such that a first and a second multi-block segment point to the first VBM but the first VBM points to the first segment and not the second segment;
rebuild a second VBM that points to the second segment;
determine if a mapping pointer (MP) is a deduplication MP or a non-deduplication MP; and
determine whether to connect the MP to the first VBM or the second VBM.

13. The apparatus as claimed in claim 12, wherein the MP is determined to be a non-deduplication MP; and wherein
determining whether to connect the MP to the first VBM or the second VBM, comprises:
comparing a first replicaID for the MP and a second replicaID for the first VBM such that the MP is excluded from connection to the first VBM if the first replicaID is less than the second replicaID;
comparing the first replicaID for the MP and a third replicaID for the second VBM such that the MP is excluded from connection to the second VBM if the first replicaID is less than the third replicaID; and
marking the MP as bad in the event that the first replicaID is less than both the second and the third replicaID.

14. The apparatus as claimed in claim 12, wherein the MP is determined to be a non-deduplication MP; and wherein
determining whether to connect the MP to the first VBM or the second VBM, comprises:
determining that the offset of the MP is found in both the first and the second VBM;
connecting the MP to the second VBM if a weight associated with the extent in the first VBM indicates that the extent is currently not part of a file in the file system; and
marking the MP as bad if the weight associated with the extent in the first VBM indicates that the extent is currently part of a file in the file system.

15. The apparatus as claimed in claim 12, wherein the MP is determined to be a non-deduplication MP; and wherein
determining whether to connect the MP to the first VBM or the second VBM, comprises:
determining that the offset of the MP is not found in both the first and the second VBM; and
marking the MP as bad based on the said determination.

16. The apparatus as claimed in claim 12, wherein the MP is determined to be a non-deduplication MP; and wherein
determining whether to connect the MP to the first VBM or the second VBM, comprises:
determining that the offset of the MP is found in the first VBM;
marking the MP as bad if a weight associated with the extent in the first VBM indicates that the extent is currently not part of a file in the file system; and
connecting the MP to the first VBM if the weight associated with the extent in the first VBM indicates that the extent is currently part of a file in the file system.

17. A computer program product having a non-transitory computer readable medium which stores a set of instructions, the set of instructions, when carried out by processing circuitry, causing the processing circuitry to perform a method of:
detecting a virtual block map (VBM) lost write in a deduplication-enabled file system, wherein the VBM lost write results in a first VBM being re-allocated such that a first and a second multi-block segment point to the first VBM but the first VBM points to the first segment and not the second segment;
rebuilding a second VBM that points to the second segment;
determining if a mapping pointer (MP) is a deduplication MP or a non-deduplication MP; and
determining whether to connect the MP to the first VBM or the second VBM.

18. The computer program product as claimed in claim 17, wherein the MP is determined to be a non-deduplication MP; and wherein
determining whether to connect the MP to the first VBM or the second VBM, comprises:
comparing a first replicaID for the MP and a second replicaID for the first VBM such that the MP is excluded from connection to the first VBM if the first replicaID is less than the second replicaID;
comparing the first replicaID for the MP and a third replicaID for the second VBM such that the MP is excluded from connection to the second VBM if the first replicaID is less than the third replicaID; and
marking the MP as bad in the event that the first replicaID is less than both the second and the third replicaID.

19. The computer program product as claimed in claim 17, wherein the MP is determined to be a non-deduplication MP; and wherein
determining whether to connect the MP to the first VBM or the second VBM, comprises:
determining that the offset of the MP is found in both the first and the second VBM;
connecting the MP to the second VBM if a weight associated with the extent in the first VBM indicates that the extent is currently not part of a file in the file system; and
marking the MP as bad if the weight associated with the extent in the first VBM indicates that the extent is currently part of a file in the file system.

20. The computer program product as claimed in claim 17, wherein the MP is determined to be a non-deduplication MP; and wherein
determining whether to connect the MP to the first VBM or the second VBM, comprises:
determining that the offset of the MP is not found in both the first and the second VBM; and
marking the MP as bad based on the said determination.
